(19) United States
(12) Patent Application Publication
(10) Pub. No.: US 2017/0214333 A1
(43) Pub. Date: Jul. 27, 2017

(54) ALTERNATING CURRENT TO DIRECT CURRENT CONVERTER

(71) Applicant: ZODIAC ACTUATION SYSTEMS, Auxerre (FR)

(72) Inventor: Vincent VEREILLE, TOULOUSE (FR)

(21) Appl. No.: 15/417,521

(22) Filed: Jan. 27, 2017

(30) Foreign Application Priority Data
Jan. 27, 2016 (FR) 16 50663

(51) Int. Cl. H02M 7/06; H02M 1/44; H02M 1/12; H02M 1/42

(52) U.S. Cl. CPC H02M 7/06; H02M 1/42; H02M 1/44; H02M 1/126

(57) ABSTRACT

An alternating current to direct current converter includes: a voltage rectifier; a capacitor; a master power factor corrector including a master correction unit and a master controller controlling master switching unit from a master signal; a slave power factor corrector including a slave correction unit and a slave controller controlling slave switching unit from a slave signal; and a synchronization module generating the master signal and the slave signal with a phase shift relative to the master signal. The master power factor corrector includes a unit for generating a reference current starting from the current on the input side of the voltage rectifier. The unit generating the reference current includes a phase compensation module capable of reducing the phase shift between the intensity and the voltage of the current on the input side of the voltage rectifier as a function of the frequency of the power supply current.

### FIELD OF THE INVENTION

This invention relates to an alternating current to direct current converter including:
an alternating power supply input, outputting an alternating power supply current,
a voltage rectifier with its input connected to the power supply input,
a capacitor connected between the ground and an output, and
a master power factor corrector comprising a master power factor correction unit and a master controller, the input of the master power factor correction unit being connected to the voltage rectifier and its output being connected to the capacitor and comprising master switching means, the master controller being capable of controlling the master switching means of the master power factor correction unit from a master control signal.

### BACKGROUND OF THE INVENTION

Alternating current to direct current converters are typically formed from a diodes bridge and an output capacitor.

The presence of such a converter is equivalent to a non-linear load on the network. This has the consequence of deforming the current circulating on the network. In particular, phase shifts appear between the network current and voltage and electromagnetic interference (EMI) is generated.

A known way in the state of the art of overcoming this difficulty is the technique of power factor correctors integrated into the converters. For example, this may consist of active power factor correctors using Buck, Boost or other type typologies.

Such a power factor corrector is adapted to keep a current with no phase shift relative to the converter input voltage and to limit the generation of electromagnetic interference.

The power factor corrector includes a power factor correction unit and a controller that controls the power factor correction unit. The controller analyses the current shape in real time to deduce a shape error in comparison with an image of the required input power supply current, in other words purely sinusoidal and with zero phase shift relative to the voltage.

However, a converter equipped with such a power factor corrector will not reduce electromagnetic interference generated on the network sufficiently. Thus, it requires significant filtering means.

### SUMMARY OF THE INVENTION

The purpose of the invention is to disclose an alternating current to direct current converter requiring reduced filter means, while guaranteeing stability regarding the network power supply.

To achieve this, the purpose of this invention is an alternating current to direct current converter including:
an alternating power supply input, outputting an alternating power supply current,
a voltage rectifier with its input connected to the power supply input,
a capacitor connected between the ground and an output, and
a master power factor corrector comprising a master power factor correction unit and a master controller, the input of the master power factor correction unit being connected to the voltage rectifier and its output being connected to the capacitor and comprising master switching means, the master controller being capable of controlling the master switching means of the master power factor correction unit from a master control signal,
at least one slave power factor corrector, the or each slave power factor corrector comprising a slave power factor correction unit and a slave controller, the input of the slave power factor correction unit being connected to the voltage rectifier and its output being connected to the capacitor and comprising slave switching means, the slave controller being capable of controlling the slave switching means of the slave power factor correction unit from a slave control signal, and
a synchronization module connected to the master controller and to the slave controller to generate the master control signal and the slave control signal, the master control signal and the slave control signal being out of phase, in which the master power factor corrector comprises means of generating a reference current from the current on the input side of the voltage rectifier, the means being connected to the input of the master controller.

Characterized in that the means of generating the reference current include a phase compensation module capable of reducing the phase shift between the intensity and the voltage of the current on the input side of the voltage rectifier as a function of the frequency of the power supply current, by adding a correction phase to the converter power supply current.

Depending on the particular embodiment, the converter according to the invention comprises one of several of the following characteristics, taken in isolation or in any technically possible combination:
the master control signal and the slave control signal are 180° out of phase;
the synchronization module comprises means capable of modulating the frequency of the master control signal and the slave control signal;
the converter comprises filter means with their input connected to the power supply input and with their output connected to the voltage rectifier;
the master power factor corrector comprises means of measuring the output voltage, these means being connected to the input of the master controller, the master controller being capable of calculating a reference regulation current from the output voltage measured by the means and the reference current, and the master controller being capable of calculating the master control signal as a function of the regulation current;
the master controller is connected to the slave controller to provide it with the reference regulation current, the slave controller being capable of calculating the slave control signal as a function of the regulation current;
the master power factor corrector comprises means of measuring the intensity of the power supply current to the master power factor correction unit, the means being connected to the input of the master controller, the master controller being capable of calculating the master control signal from the intensity of the power supply current to the master power factor correction unit measured by the means, and
the or each slave power factor corrector comprises means of measuring the intensity of the power supply current to the slave power factor correction unit, the means being connected to the input of the slave controller, the slave controller being capable of calculating the slave control signal from the intensity of the power supply current to the slave power factor correction unit measured by the means.

### BRIEF DESCRIPTION OF THE DRAWINGS

The invention will be better understood after reading the following description, given purely as examples, with reference to the appended drawings on which:

FIG. 1 is a functional diagram of the converter according to the invention,

FIG. 2 is a graph showing the phase difference between the intensity and the voltage of the power supply current of the converter in FIG. 1,

FIGS. 3 and 4 are curves illustrating a master control signal and a slave control signal respectively, generated during operation of the converter in FIG. 1,

FIGS. 5 and 6 are curves illustrating the intensity during a period of the power supply current to a master power factor correction unit and the power supply current to a slave power factor correction unit respectively, used in the composition of the converter in FIG. 1, and

FIG. 7 is a curve illustrating the intensity during a period of the current at the output from a voltage rectifier, used in the composition of the converter in FIG. 1.

### DETAILED DESCRIPTION OF THE INVENTION

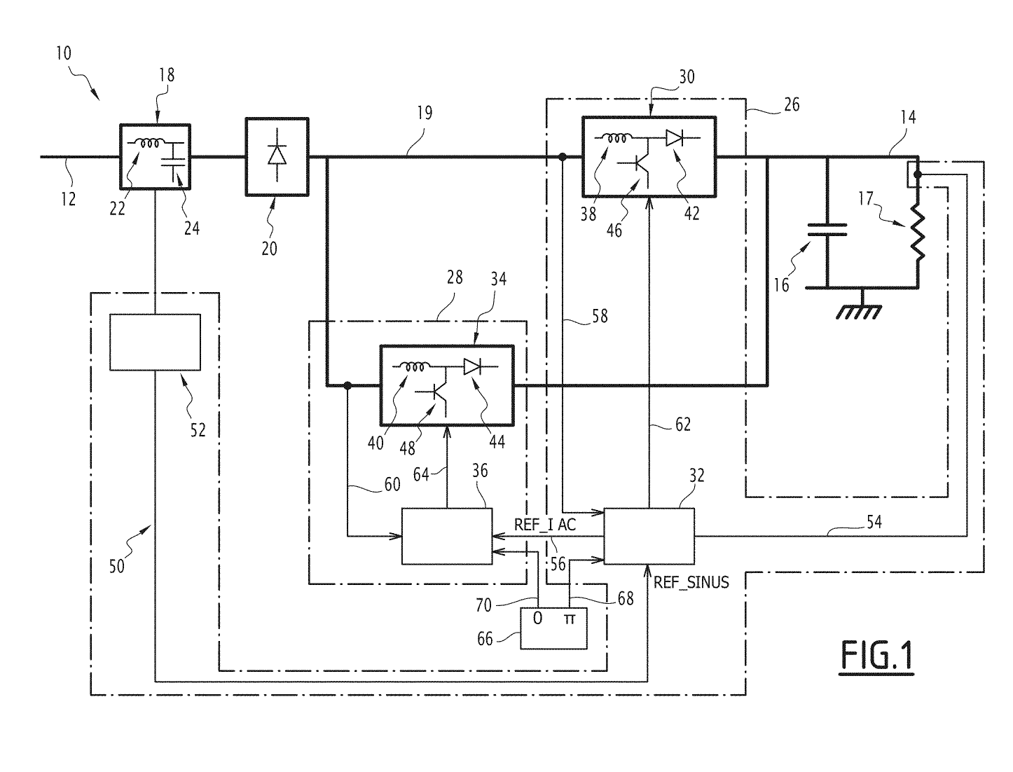

The alternating current to direct current converter 10 according to the invention illustrated on FIG. 1 includes an alternating power supply input 12, a direct current output 14 and a capacitor 16 connected to the input side of the output 14. It is capable of converting the current at the power supply input 12 such that the output voltage 14 is constant.

The converter 10 may for example be located under the seats of an aircraft to supply power to seat actuation mechanisms.

The power supply input 12 is connected to an electricity distribution system on the aircraft and it receives an alternating power supply current for which the voltage varies between approximately 90V and 130V and for which the frequency F varies between 360 Hz and 800 Hz.

The output voltage 14 is a constant voltage, for example between 200V and 220V.

As can be seen on FIG. 1, the output 14 supplies power to a load 17 that may for example by a direct current to direct current converter.

The capacitance of the capacitor 16 is between about 150 μF and 330 μF.

The converter 10 also comprises filter means 18 and a voltage rectifier 20.

The filter means 18 are capable of reducing electromagnetic interference generated by the converter 10 by filtering current harmonics.

The filter means 18 are connected to the power supply input 12 and include at least one filter coil 22 installed in series and at least one filter capacitor 24 connected to the ground.

In the embodiment illustrated in FIG. 1, the filter means 18 comprise for example a filter coil 22 for which the inductance varies between about 50 μH and 100 μH and a filter capacitor 24 for which the capacitance varies between about 100 nF and 200 nF.

The input of the voltage rectifier 20 is connected to the filter means 18 and is capable of transforming the alternating current output by the filter means 18 into a current for which the shape of the voltage is a rectified sine curve.

The voltage rectifier 20 typically includes four diodes forming a diodes bridge, also called a Graetz bridge. Its architecture is conventional and it will not be described in more detail.

The converter 10 also comprises a master power factor corrector 26 and at least one slave power factor corrector 28, for example identical to the master power factor corrector 26.

The following description applies to the case in which the converter 10 comprises a single slave power factor corrector 28. When the converter 10 comprises n slave power factor correctors 28, where n is an integer number greater than or equal to 2, the slave power factor correctors 28 are installed in parallel and the converter structure 10 is then deduced from the case described below.

The master power factor corrector 26 includes a master power factor correction unit 30 and a master power factor controller 32.

Similarly, the slave power factor corrector 28 includes a slave power factor correction unit 34 and a slave power factor controller 36.

The inputs of the master power factor correction unit 30 and of the slave power factor correction unit 34 are both connected to the voltage rectifier 20 to receive power.

The outputs of the master power factor correction unit 30 and of the slave power factor correction unit 34 are both connected to the capacitor 16.

The master power factor correction unit 30 and the slave power factor correction unit 34 are active type power factor correction units known in the state of the art. Their typologies may for example be of the Buck, Boost, Buck-Boost or other types.

In the embodiment illustrated in FIG. 1, the master power factor correction unit 30 and the slave power factor correction unit 34 are of the Boost type and each comprises a power factor correction coil 38, 40 respectively and a power factor correction diode 42, 44 respectively installed in series.

They also comprise master switching means 46 and slave switching means 48 respectively, each installed firstly between firstly the ground and secondly between the power factor correction coils 38, 40 respectively and the power factor correction diodes 42, 44 respectively.

The master switching means 46 and the slave switching means 48 are transistors, for example MOSFET type field effect transistors. The structures of the master controller 32 and the slave controller 36 are identical and they are connected to the master power factor correction unit 30 to control the master switching means 46 and to the slave power factor correction unit 34 to control the slave switching means 48, respectively.

The master power factor correction unit 30, the slave power factor correction unit 34, the master controller 32 and the slave controller 36 are adapted to operate in “continuous conduction mode” (CCM), in other words the power supply currents to each of the power factor correction coils 38, 40 respectively are never null during one period of the power supply current. They are also adapted to operate in average current regulation mode.

The master controller 32 and the slave controller 36 are capable of analyzing the shape of power supply currents to the master power factor correction unit 30 and to the slave power factor correction unit 34 respectively to control the operation of each.

To achieve this, the master power factor corrector 26 comprises means 50 of generating a reference current REF_SINUS starting from the current circulating on the input side of the voltage rectifier 20. The generation means 50 is connected to the input to the master controller 32. In particular, the reference current REF_SINUS is generated from the power supply current of the filter means 18. The generation means 50 comprise means (not shown) of determining the peak intensity and the frequency F of the power supply current to the filter means 18 to supply the reference current REF_SINUS that is an ideal current, in other words a sinusoidal current, required at the input to the converter 10, to the master controller 32.

Advantageously, the generation means 50 include a phase compensation module 52.

The phase compensation means 52 is capable of reducing the phase shift between the intensity and the voltage of the power supply current to the converter 10, as a function of the frequency F of the power supply current.

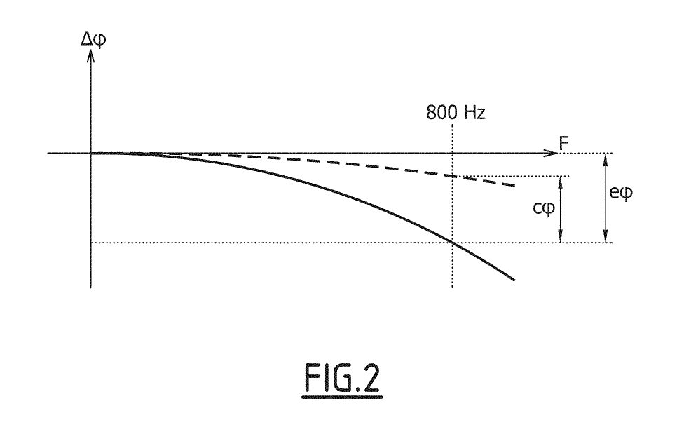

FIG. 2 illustrates the variation of the phase shift Asp between the intensity and the voltage of the power supply current of the converter 10 as a function of its frequency F.

The phase shift Δφ is practically null in low frequencies, and increases as the frequency F increases. In particular, at 800 Hz, the phase shift Δφ is equal to eφ when the generation means 50 do not include a phase compensation module 52.

As can be seen on FIG. 2, the phase compensation module 52 is capable of reducing the phase shift Δφ to make it practically null, by adding a correction phase cφ increasing with the frequency F to the power supply current of the converter 10. The master power corrector 26 also comprises means 54 of measuring the output voltage 14. The means 54 are connected to the input to the master controller 32.

The master controller 32 is capable of calculating a reference regulation current REF_IAC for its operation starting from the reference current REF_SINUS and the output voltage 14.

The master controller 32 is also connected to the slave controller 36 by connecting means 56 to supply the regulation current reference REF_IAC to it for operation of the slave controller 36.

The master power factor correction unit 26 also includes the means 58 of measuring the intensity of the current on the input side of the master power factor correction unit 30. The means 58 are connected to the input to the master controller 32.

Similarly, the slave power factor correction unit 28 includes the means 60 of measuring the intensity of the power supply current to the slave power factor correction unit 34. The means 60 are connected to the input to the slave power factor controller 36.

Starting from the comparison between the reference regulation current REF_IAC and the measurement of the intensity of the power supply current to the master power factor correction unit 30 and of the power supply current to the slave power factor correction unit 34 respectively, the master controller 32 and the slave controller 36 are each capable of controlling the master power factor correction unit 30 and the slave power factor correction unit 34 respectively.

Control consists of switching the master switching means 46 and the slave switching means 48 so as to obtain power supply currents to the master power factor correction unit 30 and to the slave power factor correction unit 34 as close as possible to the single regulation current REF_IAC.

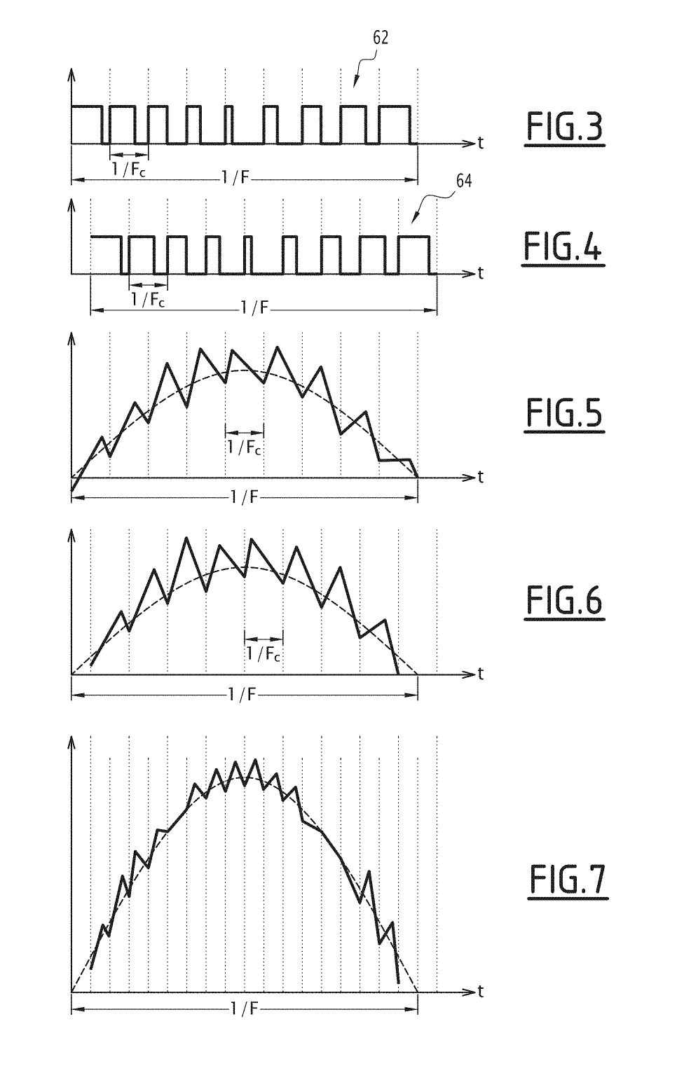

Control is applied from a master control signal 62 and a slave control signal 64 illustrated on FIGS. 3 and 4.

To achieve this, the converter 10 includes a synchronization module 66 connected to the master controller 32 by master controller synchronization connection means 68 and to the slave controller 36 by slave controller synchronization connection means 70.

The synchronization module 66 is adapted to control the generation of the master control signal 62 and the slave control signal 64, for example using a clock.

As illustrated in FIGS. 3 and 4, the master control signal 62 and the slave control signal 64 are in the shape of periodic signals with the same switching frequency Fc. They are signals of the “Pulse Width Modulation” (PWM) type.

The switching frequency Fc may for example by about 250 kHz.

The synchronization module 66 is adapted to shift the phase of the master control signal 62 relative to the slave control signal 64 such that operation of the master power factor correction unit 30 and the slave power factor correction unit 34 is interlaced.

In the embodiment illustrated in FIG. 1, the phases of the master control signal 62 and of the slave control signal 64 are 180° out of phase to achieve optimal interlacing of the master power factor correction unit 30 and of the slave power factor correction unit 34.

As illustrated in FIGS. 3 and 4, over a period 1/Fc, the master control signal 62 may for example firstly be non-null, in other words it controls opening of master switching means 46, and then null, in other words it controls closing of master switching means 46. Furthermore, the shape of the slave control signal 64 is identical to the shape of the master control signal 62, and lags behind it by a half-period ½Fc.

The synchronization module 66 advantageously comprises means (not shown on FIG. 1) capable of modulating the frequency of the master control signal 62 and the slave control signal 64.

In particular, the modulation means are adapted to modulate in a frequency range of plus or minus Δf around the switching frequency Fc, Δf being between 10 kHz and 20 kHz.

FIG. 5 illustrates the power supply current to the master power factor correction unit 30 measured by the means 58, over a period 1/F.

The power supply current to the master power factor correction unit 30 is in saw tooth form, known as “ripples”. Over a period 1/F, the saw teeth are carried by the sine curve of the power supply current to the converter 10.

Due to operation in continuous conduction mode (CCM), the saw teeth are only null when the power supply voltage to the converter 10 is null, in other words at the end of each period 1/F.

FIG. 6 illustrates the power supply current to the slave power factor correction unit 34 measured by the means 60, over a period 1/F.

The shape of the power supply current to the slave power factor correction unit 34 is similar to the shape of the power supply current to the master power factor correction unit 30 and will not be described again.

Operation of the invention will now be described.

When the master switching means 46 are closed for a period 1/Fc, the power factor correction diode 42 becomes blocked and the voltage at the terminals of the power factor correction coil 38 causes a linear increase in a current that charges it with magnetic energy. During this interval, the intensity of the power supply current to the master power factor correction unit 30 increases and defines a rising phase.

Conversely, when the master switching means 46 are open for a period 1/Fc, the power factor correction diode 42 becomes unblocked and magnetic energy stored in the power factor correction coil 38 generates a current towards the capacitor 16 to charge it. During this interval, the intensity of the power supply current to the master power factor correction unit 30 decreases and defines a falling phase.

Operation of the slave power factor control unit 34 is similar.

As can be seen on FIGS. 5 and 6, due to the 180° phase shift between the master control signal 62 and the slave control signal 64 applied by the synchronization module 66, the saw teeth of the power supply current to the slave power factor correction unit 34 lag behind the saw teeth of the power supply current to the master power factor correction unit 30.

The current at the output from the voltage rectifier 20 is equal to the sum of the power supply current of the master power factor correction unit 30 and the power supply current of the slave power factor correction unit 34. FIG. 7 illustrates the current at the output from the voltage rectifier, over a period 1/F.

As can be seen on FIG. 7, due to the lag of the saw teeth of the power supply current of the slave power factor correction unit 34 relative to the saw teeth of the power supply current of the master power factor correction unit 30, the saw teeth of the power supply currents of the power factor correction units 30, 34 partially or completely compensate each other. Consequently, the output current from the voltage rectifier 20 has more saw teeth with lower amplitude over a given period 1/F than the saw teeth of power supply currents of the power factor correction units 30, 34.

Finally, interlacing of the master power factor correction unit 30 and the slave power factor correction unit 34 reduces the fundamental switching frequency Fc in the frequency spectrum of the input current to the converter 10, and consequently transfers energy mainly at twice the frequency of the chopping frequency Fc.

Furthermore, frequency modulation of the master control signal 62 and the slave control signal 64 by the modulation means distributes spectral energy around the switching frequency Fc in a band width of plus or minus Δf, where Δf is between 10 kHz and 20 kHz. This has the effect of reducing the energy carried by the switching frequency Fc.

The converter 10 according to the invention has a number of advantages. Interlacing of power factor correction units 30, 34 has the effect of reducing electromagnetic interference, by almost entirely eliminating the fundamental switching frequency Fc in the frequency spectrum of the current at the input to the converter 10.

The reduction in electromagnetic interference is optimized when a 180° phase shift is introduced between the master control signal 62 and the slave control signal 64.

This has the consequence of reducing filter means 18 that thus comprise fewer coils 22 and capacitors 24.

Furthermore, by distributing spectral energy around the switching frequency, the frequency modulation of control signals 62, 64 further reduces the level of electromagnetic interference and consequently reduces the filter means 18 even more.

Therefore the converter 10 according to the invention has fewer filter means 18 than known converters in the state of the art.

Furthermore, the presence of the phase compensation module 52 assures stable operation of interlaced power factor correction units 30, 34 when the voltage of the power supply current of the converter 10 is low, in other words about 85V. The phase compensation module 52 also makes it possible to guarantee rejection of harmonic currents for a frequency of the power supply possibly as high as 1 kHz.

Therefore the converter 10 according to the invention consumes less apparent power at no load than known converters in the state of the art.

1. Alternating current to direct current converter comprising
an alternating power supply input, outputting an alternating power supply current,
a voltage rectifier with its input connected to the power supply input,
a capacitor connected between the ground and an output, and
a master power factor corrector comprising a master power factor correction unit and a master controller, the input of the master power factor correction unit being connected to the voltage rectifier and its output being connected to the capacitor and comprising master switching means, the master controller being capable of controlling the master switching means of the master power factor correction unit from a master control signal,
at least one slave power factor corrector, the or each slave power factor corrector comprising a slave power factor correction unit and a slave controller, the input of the slave power factor correction unit being connected to the voltage rectifier and its output being connected to the capacitor and comprising slave switching means, the slave controller being capable of controlling the slave switching means of the slave power factor correction unit from a slave control signal, and
a synchronization module connected to the master controller and to the slave controller to generate the master control signal and the slave control signal, the master control signal and the slave control signal being out of phase. characterized in that the master power factor corrector comprises means of generating a reference current starting from the current on the input side of the voltage rectifier, the means being connected to the input to the master comprise a phase compensation module capable of reducing the phase shift between the intensity and the voltage of the current on the input side of the voltage rectifier as a function of the frequency (F) of the power supply current, by adding a correction phase (cφ) to the power supply current of the converter.

2. Converter according to claim 1, in which the master control signal and the slave control signal are 180° out of phase.

3. Converter according to claim 1, in which the synchronization module comprises means capable of modulating the frequency of the master control signal and the slave control signal.

4. Converter according to claim 1, comprising filter means with their input connected to the power supply input and with their output connected to the voltage rectifier.

5. Converter according to claim 1, in which the master power factor corrector comprises means of measuring the output voltage, the means being connected to the input of the master controller, the master controller being capable of calculating a reference regulation current (REF_IAC) from the output voltage measured by the means and the reference current (REF_SINUS), and the master controller being capable of calculating the master control signal as a function of the regulation current (REF_IAC).

6. Converter according to claim 5, in which the master controller is connected to the slave controller to provide it with the reference regulation current (REF_IAC), the slave controller being capable of calculating the slave control signal as a function of the regulation current (REF_IAC).

7. Converter according to claim 1, in which the master power factor corrector comprises means of measuring the intensity of the power supply current to the master power factor correction unit, the measuring means being connected to the input of the master controller, the master controller being capable of calculating the master control signal from the intensity of the power supply current of the master power factor correction unit measured by the measuring means.

8. Converter according to claim 1, in which the or each slave power factor corrector comprises means of measuring the intensity of the power supply current to the slave power factor correction unit, the measuring means being connected to the input of the slave controller, the slave controller being capable of calculating the slave control signal from the intensity of the power supply current of the slave power factor correction unit measured by the measuring means.
